(19) United States
(12) Patent Application Publication
(10) Pub. No.: US 2025/0331458 A1
(43) Pub. Date: Oct. 30, 2025

(54) STALK CUTTING ASSEMBLY FOR AN AGRICULTURAL HARVESTER ROW UNIT

(71) Applicant: CNH Industrial America LLC, New Holland, PA (US)

(72) Inventor: Niels Dybro, Muscatine, IA (US)

(21) Appl. No.: 19/090,919

(22) Filed: Mar. 26, 2025

Related U.S. Application Data
(60) Provisional application No. 63/638,136, filed on Apr. 24, 2024.

(51) Int. Cl. A01D 45/02; A01D 43/08

(52) U.S. Cl. CPC A01D 45/021; A01D 43/08

(57) ABSTRACT

A stalk cutting assembly for a row unit of an agricultural harvester includes a shaft configured to extend generally along a vertical axis of the row unit. The stalk cutting assembly also includes a set of discs distributed along the shaft. Each disc of the set of discs is non-rotatably coupled to the shaft, and the shaft is configured to rotate to drive the set of discs to rotate. Furthermore, the set of discs is configured to engage a plant stalk to cut the plant stalk into multiple sections.

### CROSS-REFERENCE TO RELATED APPLICATION

This application claims priority from and the benefit of U.S. Provisional Application Ser. No. 63/638,136, entitled “STALK CUTTING ASSEMBLY FOR AN AGRICULTURAL HARVESTER ROW UNIT”, filed Apr. 24, 2024, which is hereby incorporated by reference in its entirety.

### BACKGROUND

The present disclosure relates generally to a stalk cutting assembly for an agricultural harvester row unit.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

Certain row units include two rotors, and each rotor includes multiple spindles (e.g., barbed spindles) configured to engage a crop (e.g., a cotton plant). The rotors may be positioned on opposite sides of a central path or on the same side of the central path, and the spindles extend into the central path. During operation of the agricultural harvester, the row unit is positioned to align a row of crops with the central path. Accordingly, as the agricultural harvester traverses the field, the spindles of the rotors engage each plant of the row. The rotors are driven to rotate, such that engagement of the spindles with the crop separates the agricultural product (e.g., seed cotton) from the plant stalk. The agricultural product collects on the spindles and is removed from the spindles by doffers, which are positioned adjacent to the rotors. The air-assisted conveying system moves the agricultural product from the row unit to the accumulator. After the agricultural product is removed from the spindles of each rotor, the spindles pass through a respective moistener column assembly to remove buildup of crop liquids (e.g., sap, etc.) from the spindles. Rotation of the rotors then drives the spindles to engage a subsequent crop, while the plant stalk remains attached to the ground. After the harvesting operation is complete, a mower traverses the field to chop the plant stalks into segments prior to subsequent agricultural operations within the field.

### BRIEF DESCRIPTION

In certain embodiments, a stalk cutting assembly for a row unit of an agricultural harvester includes a shaft configured to extend generally along a vertical axis of the row unit. The stalk cutting assembly also includes a set of discs distributed along the shaft. Each disc of the set of discs is non-rotatably coupled to the shaft, and the shaft is configured to rotate to drive the set of discs to rotate. Furthermore, the set of discs is configured to engage a plant stalk to cut the plant stalk into multiple sections.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a schematic top view of an embodiment of a row unit that may be employed within the header of FIG. 1;

FIG. 3 is a top perspective view of the row unit of FIG. 2; and

FIG. 4 is a bottom perspective view of the row unit of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

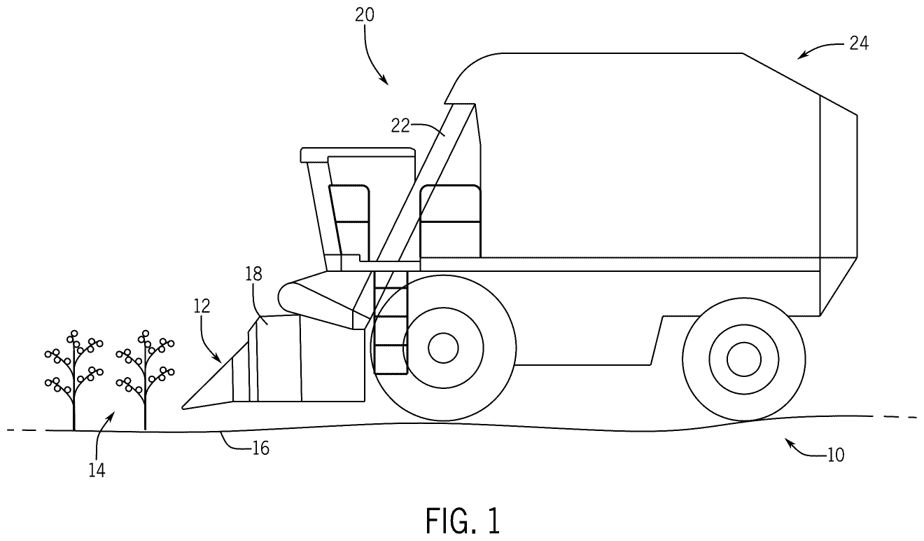

FIG. 1 is a side view of an embodiment of an agricultural harvester 10 having a header 12. The agricultural harvester 10 is configured to harvest agricultural product 14 (e.g., seed cotton) from a field 16 and to form the agricultural product 14 into bales (e.g., agricultural bales). In the illustrated embodiment, the header 12 of the agricultural harvester 10 includes multiple row units 18 distributed across the width of the header 12. Each row unit 18 is configured to harvest a respective row of the agricultural product 14 from the field 16. Additionally, the agricultural harvester 10 includes an agricultural product transport assembly 20 having an air-assisted conveying system 22 configured to move the agricultural product 14 from the row units 18 of the header 12 to an accumulator of the agricultural product transport assembly 20. The agricultural product transport assembly 20 also includes a conveying system configured to convey the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

As discussed in detail below, each row unit 18 includes two rotors positioned on opposite sides of a central path through the row unit 18 or on the same side of the central path. Each rotor includes multiple spindles (e.g., barbed spindles) extending into the central path, and the spindles are configured to engage a crop (e.g., cotton plant) along a substantial portion of the height of the crop. During operation of the agricultural harvester 10, the central path of the row unit 18 is aligned with a row of crops. Accordingly, as the agricultural harvester 10 traverses the field 16, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and the air-assisted conveying system 22 moves the agricultural product from the conveying chambers to the accumulator. After the agricultural product is removed from the spindles of each rotor, the spindles pass through a respective moistener column assembly to remove buildup of crop liquids (e.g., sap, etc.) from the spindles. As the rotors continue to rotate, the spindles engage a subsequent crop at the central path, while the plant stalk remains attached to the ground.

As discussed in detail below, the row unit includes a stalk cutting assembly positioned downstream from the rotors along the central path. The stalk cutting assembly includes a shaft extending generally along a vertical axis of the row unit and multiple discs distributed along the shaft. Each disc is non-rotatably coupled to the shaft, and the shaft is configured to rotate to drive the discs to rotate. The discs are configured to engage the plant stalk to cut the plant stalk into sections. Accordingly, the plant stalks are chopped as the agricultural harvester traverses the field, thereby obviating a subsequent mowing operation. As a result, the efficiency of the harvesting process may be significantly enhanced.

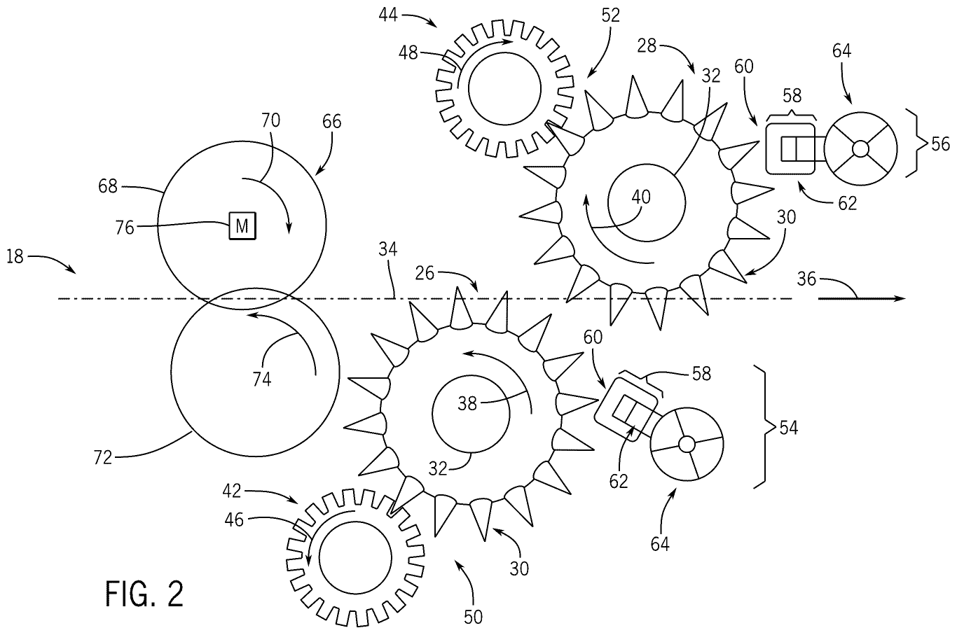

FIG. 2 is a schematic top view of an embodiment of a row unit 18 that may be employed within the header of FIG. 1. In the illustrated embodiment, the row unit 18 includes a first rotor 26 and a second rotor 28. As illustrated, each rotor includes multiple spindles 30 (e.g., barbed spindles) configured to engage a crop (e.g., cotton plant). For example, each spindle 30 may include three rows of barbs. Each rotor includes a central shaft 32 (e.g., rotor shaft) and multiple discs coupled to the central shaft 32. Each rotor also includes multiple spindle bars pivotally coupled to the discs. The spindle bars extend along a vertical axis of the row unit 18, and the spindle bars are circumferentially distributed (e.g., evenly circumferentially distributed) about the discs. The spindles 30 extend radially outward from each spindle bar, the spindles 30 coupled to each spindle bar are distributed along the vertical axis of the row unit 18, and the spindles 30 coupled to each spindle bar point in the same direction. Because the spindles 30 are distributed along the vertical axis, the spindles 30 engage the crop along a substantial portion of the height of the crop. Furthermore, an orientation control arm is coupled to each spindle bar, a roller is coupled to an end of each orientation control arm, and the rollers engage a cam track. The cam track is configured to control the orientation of each spindle bar relative to the discs as the rotor rotates, thereby controlling an orientation of the spindles with respect to the crop, with respect to a doffer, and with respect to a moistener column assembly. In addition, each spindle 30 is driven to rotate relative to the respective spindle bar. For example, a spindle drive gear may be coupled to each spindle bar, a spindle gear may be coupled to each spindle, the spindle drive gear may be driven to rotate by rotation of the rotor, and the spindle drive gear may drive the spindle gears to rotate. As each spindle engages the agricultural product, rotation of the spindle drives the barbs to capture the agricultural product (e.g., seed cotton lint), such that the agricultural product wraps around the spindle.

In the illustrated embodiment, the first rotor 26 and the second rotor 28 are positioned on opposite sides of a central path 34 through the row unit 18, and the spindles 30 of each rotor extend into the central path 34. During operation of the agricultural harvester, the central path 34 of the row unit 18 is aligned with a row of crops. Accordingly, as the agricultural harvester traverses the field along a direction of travel 36, the row unit 18 receives each crop of the row, and the spindles 30 of each rotor engage the crop. The first rotor 26 is driven to rotate in a first rotor rotational direction 38, and the second rotor 28 is driven to rotate in a second rotor rotational direction 40, opposite the first rotor rotational direction 38. The rotational speed of each rotor may be selected such that the tangential speed of the spindles 30 due to rotation of the rotor is equal to the ground speed of the row unit 18 along the direction of travel 36, thereby enabling the spindles 30 to engage the crop at a substantially zero relative speed. Engagement of the spindles 30 with the crop separates the agricultural product (e.g., seed cotton) from the plant stalk (e.g., the crop after the agricultural product is removed). While the first and second rotors are positioned on opposite sides of the central path in the illustrated embodiment, in other embodiments, the first and second rotors may be positioned on the same side of the central path.

The agricultural product removed from the crop collects on the spindles 30 of the rotors. In the illustrated embodiment, the row unit 18 includes a first doffer 42 configured to remove the agricultural product from the spindles 30 of the first rotor 26, and the row unit 18 includes a second doffer 44 configured to remove the agricultural product from the spindles 30 of the second rotor 28. Each doffer includes a stack of discs configured to engage the spindles 30 of the respective rotor to remove the agricultural product from the spindles 30. The number of discs of each doffer may be equal to the number of spindles on each spindle bar. As illustrated, the first doffer 42 is configured to rotate in a first doffer rotational direction 46, which is the same as the first rotor rotational direction 38, and the second doffer 44 is configured to rotate in a second doffer rotational direction 48, which is the same as the second rotor rotational direction 40. Each doffer rotates at a rotational speed that establishes a doffer tangential speed greater than a tangential speed of the spindles due to rotation of the spindles relative to the respective spindle bars. Accordingly, the interaction between the discs of the doffer and the spindles 30 of the respective rotor unwinds the agricultural product (e.g., seed cotton lint) from the spindles 30, thereby removing the agricultural product and directing the agricultural product to a respective conveying chamber. As illustrated, a first conveying chamber 50 is positioned adjacent to the first doffer 42 and the first rotor 26, and a second conveying chamber 52 is positioned adjacent to the second doffer 44 and the second rotor 28. The air-assisted conveying system moves the agricultural product from each conveying chamber to the accumulator.

After the agricultural product is removed from the spindles 30 of the first rotor 26, the spindles 30 pass through a first moistener column assembly 54, and after the agricultural product is removed from the spindles 30 of the second rotor 28, the spindles 30 pass through a second moistener column assembly 56. Each moistener column assembly is configured to remove crop liquids (e.g., sap, etc.) from the spindles 30. In the illustrated embodiment, each moistener column assembly includes multiple moistener pad assemblies 58 distributed along the vertical axis of the row unit. The number of moistener pad assemblies 58 may be equal to the number of spindles 30 on each spindle bar. Each moistener pad assembly 58 includes a moistener pad 60 and a moistener pad holder 62 configured to support the moistener pad 60. Each moistener column assembly also includes a moistener column 64 configured to direct cleaning fluid to each moistener pad assembly 58. The moistener pads 60 are positioned to engage respective spindles 30 as the respective rotor rotates, thereby applying the cleaning fluid to the spindles 30 and wiping the crop liquids off the spindles 30. As the rotors continue to rotate, the spindles 30 engage a subsequent crop at the central path 34.

In the illustrated embodiment, the row unit 18 includes a stalk cutting assembly 66 positioned downstream from the rotors with respect to the direction of travel 36. As discussed in detail below, the stalk cutting assembly 66 includes a first shaft extending generally along the vertical axis of the row unit 18, and the stalk cutting assembly 66 includes a first set of discs 68 distributed along the first shaft and non-rotatably coupled to the first shaft. The first shaft is configured to rotate in a first disc rotational direction 70 to drive the first set of discs 68 to rotate in the first disc rotational direction 70. In addition, the stalk cutting assembly 66 includes a second shaft extending generally along the vertical axis of the row unit 18, and the stalk cutting assembly 66 includes a second set of discs 72 distributed along the second shaft and non-rotatably coupled to the second shaft. The second shaft is configured to rotate in a second disc rotational direction 74 to drive the second set of discs 72 to rotate in the second disc rotational direction 74.

As illustrated, the first set of discs 68 and the second set of discs 72 overlap the central path 34. Accordingly, the first set of discs 68 and the second set of discs 72 engage the plant stalk as the row unit moves along the direction of travel 36. Engagement between the plant stalk and the sets of discs cuts the plant stalk into multiple sections. For example, in certain embodiments, each disc of the first set of discs 68 is positioned proximate to a respective disc of the second set of discs 72 along the rotational axes of the shafts (e.g., along the vertical axis) to establish a sheer cutting force on the plant stalk, which cuts the plant stalk. Because the plant stalks are chopped as the agricultural harvester traverses the field, a subsequent mowing operation is obviated, thereby significantly enhancing the efficiency of the harvesting process (e.g., by reducing fuel usage and operator/equipment time associated with the subsequent mowing operation).

In the illustrated embodiment, the stalk cutting assembly 66 includes a motor 76 configured to drive the first shaft to rotate, thereby driving the first set of discs 68 to rotate. The motor 76 may include any suitable type(s) of motor(s), such as electric motor(s), hydraulic motor(s), pneumatic motor(s), etc. Furthermore, as discussed in detail below, the stalk cutting assembly 66 includes a first gear non-rotatably coupled to the first shaft, and the stalk cutting assembly 66 includes a second gear non-rotatably coupled to the second shaft. The first and second gears are engaged with one another. Accordingly, rotation of the first shaft drives rotation of the second shaft, thereby driving the second set of discs 72 to rotate. Furthermore, in certain embodiments, the gears are directly engaged with one another, such that the second disc rotational direction 74 is opposite the first disc rotational direction 70. In addition, in certain embodiments, the gears may be indirectly engaged with one another (e.g., via a chain, via other gear(s), etc.). In such embodiments, the first and second disc rotational directions may be the same. Furthermore, in certain embodiments, the first and second shafts may be coupled to one another via a belt/pullies assembly or any other suitable assembly configured to drive rotation of the second shaft in response to rotation of the first shaft. In addition, in certain embodiments, the motor may be configured to drive the second shaft, and the first shaft may be driven to rotate by the connection between the shafts.

In certain embodiments, the motor may be omitted, and the shafts of the stalk cutting assembly may be driven to rotate by the rotor(s). For example, one rotor (e.g., the first rotor) may be coupled to one stalk cutting assembly shaft by a suitable connection (e.g., gears, gears/chain, belt/pullies, etc.). In certain embodiments, a gear non-rotatably coupled to the shaft of the rotor may be engaged (e.g., directly or via a chain) with the first gear non-rotatably coupled to the first shaft of the stalk cutting assembly or to the second gear non-rotatably coupled to the second shaft of the stalk cutting assembly. In addition, the shafts of the stalk cutting assembly may be coupled to one another by a suitable connection (e.g., gears, gears/chain, belt/pullies, etc.). Accordingly, rotation of the rotor drives both sets of discs of the stalk cutting assembly to rotate. Because the shafts of the stalk cutting assembly are driven to rotate by the rotor, the rotational speed of the sets of discs is proportional to the rotational speed of the rotor. In embodiments in which the rotational speed of the rotor is selected based on the ground speed of the row unit, the rotational speed of the sets of discs may be proportional to the ground speed of the row unit. Furthermore, in certain embodiments, each rotor may be coupled to a respective stalk cutting assembly shaft by a suitable connection (e.g., gears, gears/chain, belt/pullies, etc.). Accordingly, rotation of each rotor drives the respective set of discs of the stalk cutting assembly to rotate. Because the shafts of the stalk cutting assembly are driven to rotate by the respective rotors, the rotational speed of each set of discs is proportional to the rotational speed of the respective rotor.

In the illustrated embodiment, the stalk cutting assembly 66 includes the first set of discs 68 and the second set of discs 72. However, in other embodiments, the stalk cutting assembly may include a single set of discs. For example, in certain embodiments, the stalk cutting assembly may include one set of discs distributed along a respective shaft and a drum positioned adjacent to the set of discs. The drum may be driven to rotate by a motor, by a gear, by a pulley, etc. The drum may be spaced apart from the outer periphery of the set of discs by a distance less than an expected diameter of the plant stalk. Accordingly, the set of discs may cut the plant stalk as the row unit moves along the direction of travel. Furthermore, while the stalk cutting assembly 66 is disclosed herein with regard to one row unit 18, the stalk cutting assembly 66 may be employed within other row units of the header. For example, in certain embodiments, each row unit of the header may include a respective stalk cutting assembly.

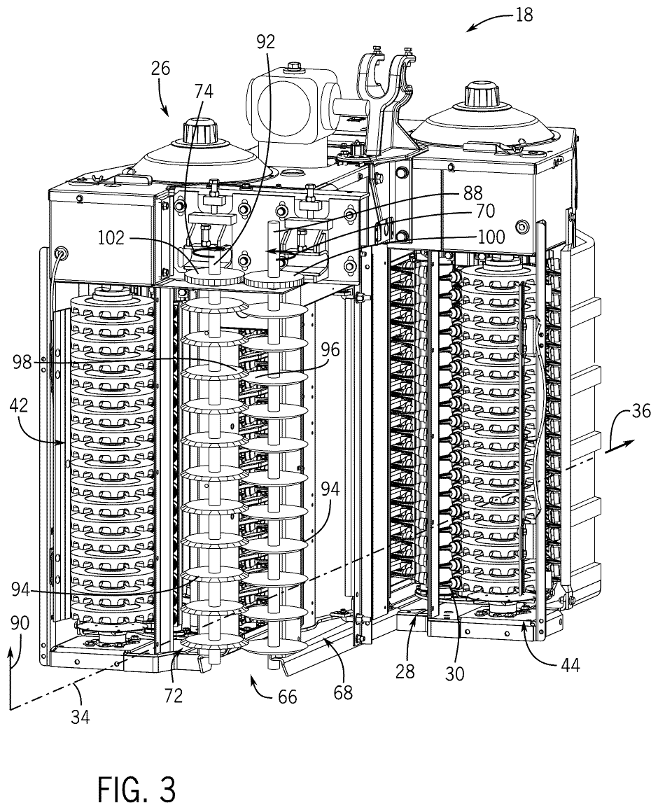

FIG. 3 is a top perspective view of the row unit 18 of FIG. 2. As previously discussed, the stalk cutting assembly 66 is positioned downstream from the rotors along the direction of travel 36. As illustrated, the first shaft 88 of the stalk cutting assembly 66 extends generally along the vertical axis 90 of the row unit 18. In addition, the first set of discs 68 are distributed along the first shaft 88, and the first set of discs 68 are non-rotatably coupled to the first shaft 88. As previously discussed, the first shaft 88 is configured to rotate in the first disc rotational direction 70 to drive the first set of discs 68 to rotate in the first disc rotational direction 70. Furthermore, the second shaft 92 of the stalk cutting assembly 66 extends generally along the vertical axis 90 of the row unit 18. In addition, the second set of discs 72 are distributed along the second shaft 92, and the second set of discs 72 are non-rotatably coupled to the second shaft 92. As previously discussed, the second shaft 92 is configured to rotate in the second disc rotational direction 74 to drive the second set of discs 72 to rotate in the second disc rotational direction 74.

As illustrated, the first set of discs 68 and the second set of discs 72 overlap the central path 34. Accordingly, the first set of discs 68 and the second set of discs 72 engage the plant stalk as the row unit moves along the direction of travel 36. Engagement between the plant stalk and the first and second sets of discs cuts the plant stalk into multiple sections. The sections of the plant stalk fall unto the surface of the field and break down over a period of time, thereby providing additional nutrients to the soil. Because the plant stalks are chopped as the agricultural harvester traverses the field, a subsequent mowing operation is obviated, thereby significantly enhancing the efficiency of the harvesting process (e.g., by reducing fuel usage and operator/equipment time associated with the subsequent mowing operation).

In the illustrated embodiment, the first set of discs 68 includes eleven discs 94, and the second set of discs 72 includes eleven discs 94. However, in other embodiments, the first set of discs may include more or fewer discs (e.g., 1, 2, 3, 4, 5, 6, 7, 8, 9, 10, 12, 13, 14, 15, 16, 17, 18, 19, 20, or more), and/or the second set of discs may include more or fewer discs (e.g., 1, 2, 3, 4, 5, 6, 7, 8, 9, 10, 12, 13, 14, 15, 16, 17, 18, 19, 20, or more). The number of discs 94 may be selected based on a desired number of segments. For example, the eleven discs of each set of discs may cut the stalk into eleven segments. Furthermore, the spacing between the discs 94 of each set of discs along the respective shaft may be selected to establish desired segments size(s) of the plant stalk. For example, in certain embodiments, the discs 94 of each set of discs may be substantially equally spaced apart from one another along the respective shaft.

Furthermore, in the illustrated embodiment, each disc 94 of the first set of discs 68 is positioned proximate to a respective disc 94 of the second set of discs 72 along the rotational axes of the shafts (e.g., along the vertical axis) to establish a sheer cutting force on the plant stalk, which cuts the plant stalk at the pair of discs. Accordingly, in the illustrated embodiment, the stalk cutting assembly 66 is configured to cut the plant stalk into twelve segments because the stalk cutting assembly 66 includes eleven pairs of discs 94. As used herein with regard to the discs, “proximate” refers to a spacing between respective discs (e.g., discs of a pair, including one disc of the first set of discs and one disc of the second set of discs) along the rotational axes of the shafts (e.g., along the vertical axis) small enough to establish the sheer cutting force (e.g., less than 20 mm, less than 10 mm, less than 5 mm, less than 2 mm, etc.). In certain embodiments, the pairs of discs are substantially equally spaced apart from one another along the rotational axes of the shafts. However, in other embodiments, the pairs of discs may be unevenly spaced along the rotational axes of the shafts (e.g., the spacing between pairs of discs may be smaller at the bottom of the stalk cutting assembly).

In addition, in the illustrated embodiment, each disc 94 of the first set of discs 68 has a flat side 96 and a tapered side 98, and each disc 94 of the second set of discs 72 has a flat side 96 and a tapered side 98. The flat side 96 of each disc 94 of the first set of discs 68 faces the flat side 96 of the respective disc 94 of the second set of discs 72. The taper of each disc 94 establishes a sharp cutting edge, thereby facilitating cutting the plant stalk. Because the flat sides 96 of the respective discs 94 (e.g., discs of a pair, including one disc of the first set of discs and one disc of the second set of discs) face each other, the cutting edges of the respective discs 94 may be positioned closer to one another along the rotational axes of the shafts (e.g., as compared to the tapered sides facing one another, or the tapered side facing a flat side). The sheer cutting force applied by each pair of discs replicates the cutting action of a pair of scissors. Accordingly, each disc may be sharpened in a similar manner to a blade of a pair of scissors.

While the flat side 96 of each disc 94 of the first set of discs 68 faces the flat side 96 of the respective disc 94 of the second set of discs 72 in the illustrated embodiment, in other embodiments, the tapered side of at least one disc of the first set of discs may face the flat side of the respective disc of the second set of discs, the flat side of at least one disc of the first set of discs may face the tapered side of the respective disc of the second set of discs, the tapered side of at least one disc of the first set of discs may face the tapered side of the respective disc of the second set of discs, or a combination thereof. In addition, while each disc 94 has a flat side 96 and a tapered side 98 in the illustrated embodiment, in other embodiments, at least one disc may have another suitable configuration. For example, in certain embodiments, at least one disc may have two tapered sides.

Furthermore, while each disc 94 of the first set of discs 68 is positioned proximate to a respective disc 94 of the second set of discs 72 along the rotational axes of the shafts in the illustrated embodiment, in other embodiments, at least one disc of the first set of discs may not be proximate to a respective disc of the second set of discs along the rotational axes of the shafts. For example, the respective discs may be spaced apart from one another along the rotational axes of the shafts by a distance that does not establish a sheer cutting force on the plant stalk.

In the illustrated embodiment, each disc 94 of the first set of discs 68 is notched, and each disc 94 of the second set of discs 72 is notched. The notches may facilitate feeding of the plant stalk into the discs 94, thereby enhancing the cutting effectiveness of the stalk cutting assembly 66. The size of the notches may be selected based on the expected diameter of the plant stalks. For example, finer notching may be used for smaller diameter plant stalks, and courser notching may be used for larger diameter plant stalks. While each disc 94 of the first set of discs 68 is notched and each disc of the second set of discs 72 is notched in the illustrated embodiment, in other embodiments, at least one disc of the first set of discs may not be notched, and/or at least one disc of the second set of discs may not be notched. For example, in certain embodiments, none of the discs of the stalk cutting assembly may be notched.

As previously discussed, the stalk cutting assembly 66 includes a first gear 100 (e.g., first stalk cutting assembly gear) non-rotatably coupled to the first shaft 88, and the stalk cutting assembly 66 includes a second gear 102 (e.g., second stalk cutting assembly gear) non-rotatably coupled to the second shaft 92. The first and second gears are engaged with one another. Accordingly, rotation of the first shaft 88 drives rotation of the second shaft 92, thereby driving the second set of discs 72 to rotate. In the illustrated embodiment, the gears are directly engaged with one another, such that the second disc rotational direction 74 is opposite the first disc rotational direction 70. However, in certain embodiments, the gears may be indirectly engaged with one another (e.g., via a chain, via other gear(s), etc.). In such embodiments, the first and second disc rotational directions may be the same. Furthermore, in certain embodiments, the first and second shafts may be coupled to one another via a belt/pullies assembly or any other suitable assembly configured to drive rotation of the second shaft in response to rotation of the first shaft. In certain embodiments, the connection between the first and second shafts may cause the shafts to rotate at the same speed (e.g., due to the gear ratio between the first and second gears, the diameters of the pullies, etc.). Furthermore, in certain embodiments, the connection between the first and second shafts may cause one shaft to rotate at a different speed than the other shaft (e.g., faster or slower).

As previously discussed, each shaft of the stalk cutting assembly 66 extends generally along the vertical axis 90 of the row unit 18. As used herein with regard to the shafts of the stalk cutting assembly, “extend generally along the vertical axis” refers to an angle between the rotational axis of the shaft and the vertical axis 90 of less than a threshold value. For example, the threshold value may be 40 degrees, 30 degrees, 20 degrees, 10 degrees, or 5 degrees. In certain embodiments, the rotational axis of each shaft of the stalk cutting assembly extends along the vertical axis of the row unit. However, in other embodiments, the rotational axes of the shafts of the stalk cutting assembly may be angled relative to the vertical axis. For example, in certain embodiments, the rotational axes of the shafts of the stalk cutting assembly may be angled such that a top end of each shaft is positioned forward of a bottom end of the shaft relative to the direction of travel. Accordingly, the discs at the top of the stalk cutting assembly may cut the plant stalk before the discs at the bottom of the stalk cutting assembly. As a result, the load on the stalk cutting assembly may be more evenly distributed over a period of time, thereby reducing a maximum load on the stalk cutting assembly. Furthermore, in certain embodiments, the rotational axis of each shaft of the stalk cutting assembly may be parallel to the rotational axes of the central shafts of the rotors (e.g., which may be oriented between zero and two degrees of the vertical axis). In addition, in certain embodiments, the angle between the rotational axis of each shaft of the stalk cutting assembly and the rotational axes of the center shafts of the rotors may be less than 40 degrees, 30 degrees, 20 degrees, 10 degrees, or 5 degrees.

In the illustrated embodiment, the rotational axes of the shafts of the stalk cutting assembly 66 are parallel to one another. However, in other embodiments, the rotational axes of the shafts of the stalk cutting assembly may be angled relative to one another. Furthermore, in the illustrated embodiment, each disc of the stalk cutting assembly is oriented perpendicularly to the rotational axis of the respective shaft. However, in other embodiments, at least one disc may be oriented at another suitable angle relative to the rotational axis of the respective shaft.

In the illustrated embodiment, the stalk cutting assembly 66 includes the first set of discs 68 and the second set of discs 72. However, in other embodiments, the stalk cutting assembly may include a single set of discs. For example, in certain embodiments, the stalk cutting assembly may include one set of discs distributed along a respective shaft and a drum positioned adjacent to the set of discs. The drum may be driven to rotate by a motor, by a gear, by a pulley, etc. The drum may be spaced apart from the outer periphery of the set of discs by a distance significantly less than an expected diameter of the plant stalk. Accordingly, the set of discs may cut the plant stalk as the row unit moves along the direction of travel. Furthermore, in certain embodiments, the drum may be spaced apart from the outer periphery of the set of discs by a distance slightly less than the expected diameter of the plant stalk. Accordingly, the set of discs may crimp the plant stalk as the row unit moves along the direction of travel. The crimps in the plant stalk may cause the plant stalk to fall to the ground and to break down more rapidly than a non-crimped plant stalk. In addition, in certain embodiments, the drum may have grooves, and the discs may engage the grooves. Furthermore, in certain embodiments, the drum may be driven to rotate at the same rotational speed as the set of discs. However, in other embodiments, the drum may be driven to rotate slower than the set of discs (e.g., to enhance the cutting effectiveness of the discs).

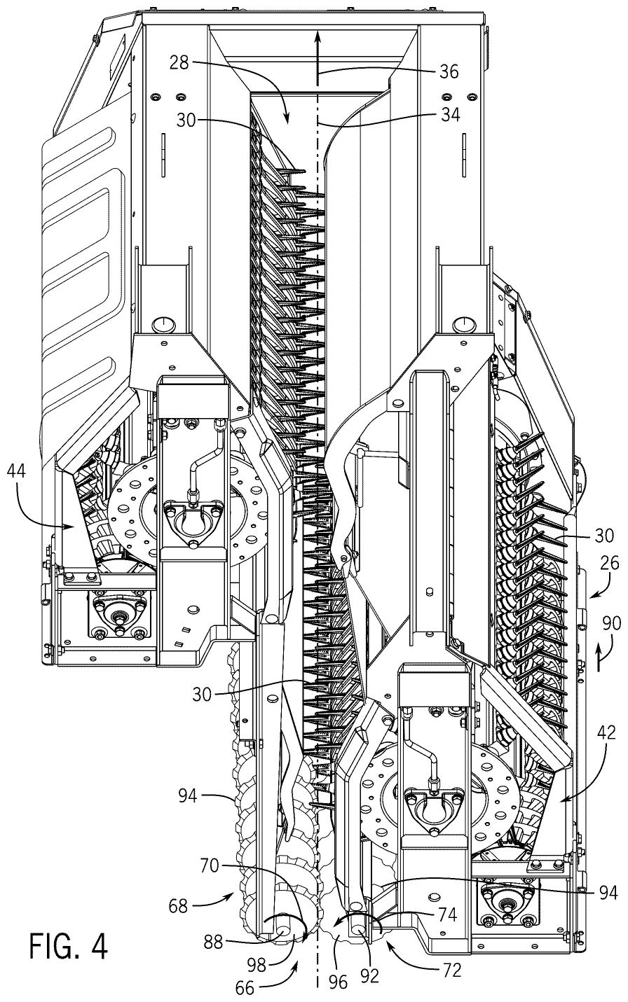

FIG. 4 is a bottom perspective view of the row unit 18 of FIG. 2. As previously discussed, the flat side 96 of each disc 94 of the first set of discs 68 faces the flat side 96 of the respective disc 94 of the second set of discs 72. Because the flat sides 96 of the respective discs 94 face each other, the cutting edges of the respective discs 94 may be positioned closer to one another along the rotational axes of the shafts (e.g., as compared to the tapered sides facing one another, or the tapered side facing a flat side). While the flat side 96 of each disc 94 of the first set of discs 68 faces the flat side 96 of the respective disc 94 of the second set of discs 72 in the illustrated embodiment, in other embodiments, the tapered side of at least one disc of one set of discs may face the flat side of the respective disc of the other set of discs, and/or the tapered side of at least one disc of one set of discs may face the tapered side of the respective disc of the other set of discs.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A stalk cutting assembly for a row unit of an agricultural harvester, comprising:
a shaft configured to extend generally along a vertical axis of the row unit; and
a plurality of discs distributed along the shaft, wherein each disc of the plurality of discs is non-rotatably coupled to the shaft, and the shaft is configured to rotate to drive the plurality of discs to rotate;
wherein the plurality of discs is configured to engage a plant stalk to cut the plant stalk into a plurality of sections.

2. The stalk cutting assembly of claim 1, wherein at least one disc of the plurality of discs is notched.

3. The stalk cutting assembly of claim 1, comprising a motor configured to drive the shaft to rotate.

4. The stalk cutting assembly of claim 1, comprising a stalk cutting assembly gear non-rotatably coupled to the shaft, wherein the stalk cutting assembly gear is configured to engage a corresponding gear coupled to a rotor shaft of a rotor of the row unit to enable rotation of the rotor to drive rotation of the shaft of the stalk cutting assembly.

5. The stalk cutting assembly of claim 1, comprising:
a second shaft configured to extend generally along the vertical axis of the row unit; and
a second plurality of discs distributed along the second shaft, wherein each disc of the second plurality of discs is non-rotatably coupled to the second shaft, and the second shaft is configured to rotate to drive the second plurality of discs to rotate;
wherein the second plurality of discs is configured to engage the plant stalk to cut the plant stalk into the plurality of sections.

6. The stalk cutting assembly of claim 5, wherein each disc of the plurality of discs is positioned proximate to a respective disc of the second plurality of discs to establish a sheer cutting force on the plant stalk.

7. The stalk cutting assembly of claim 6, wherein each disc of the plurality of discs has a flat side and a tapered side, each disc of the second plurality of discs has a flat side and a tapered side, and the flat side of each disc of the plurality of discs faces the flat side of the respective disc of the second plurality of discs.

8. The stalk cutting assembly of claim 5, wherein at least one disc of the plurality of discs is notched, at least one disc of the second plurality of discs is notched, or a combination thereof.

9. A row unit of an agricultural harvester, comprising:
a rotor having a plurality of spindles, wherein the rotor is configured to rotate to drive the plurality of spindles to remove agricultural product from a plant stalk of the crop;
a doffer configured to remove the agricultural product from the plurality of spindles; and
a stalk cutting assembly positioned downstream from the rotor, wherein the stalk cutting assembly, comprises:
a shaft, wherein an angle between a rotational axis of the shaft of the stalk cutting assembly and a rotational axis of a rotor shaft of the rotor is less than 40 degrees; and
a plurality of discs distributed along the shaft, wherein each disc of the plurality of discs is non-rotatably coupled to the shaft, and the shaft is configured to rotate to drive the plurality of discs to rotate;
wherein the plurality of discs is configured to engage the plant stalk to cut the plant stalk into a plurality of sections.

10. The row unit of claim 9, wherein at least one disc of the plurality of discs is notched.

11. The row unit of claim 9, wherein the rotational axis of the shaft of the stalk cutting assembly is parallel to the rotational axis of the rotor shaft of the rotor.

12. The row unit of claim 9, wherein the stalk cutting assembly comprises a stalk cutting assembly gear non-rotatably coupled to the shaft, and the stalk cutting assembly gear is configured to engage a corresponding gear coupled to the rotor shaft of the rotor to enable rotation of the rotor to drive rotation of the shaft of the stalk cutting assembly.

13. The row unit of claim 9, wherein the stalk cutting assembly comprises:
a second shaft configured to extend generally along the vertical axis of the row unit; and
a second plurality of discs distributed along the second shaft, wherein each disc of the second plurality of discs is non-rotatably coupled to the second shaft, and the second shaft is configured to rotate to drive the second plurality of discs to rotate;
wherein the second plurality of discs is configured to engage the plant stalk to cut the plant stalk into the plurality of sections.

14. The row unit of claim 13, wherein each disc of the plurality of discs is positioned proximate to a respective disc of the second plurality of discs to establish a sheer cutting force on the plant stalk.

15. The row unit of claim 14, wherein each disc of the plurality of discs has a flat side and a tapered side, each disc of the second plurality of discs has a flat side and a tapered side, and the flat side of each disc of the plurality of discs faces the flat side of the respective disc of the second plurality of discs.

16. The row unit of claim 13, wherein at least one disc of the plurality of discs is notched, at least one disc of the second plurality of discs is notched, or a combination thereof.

17. A stalk cutting assembly for a row unit of an agricultural harvester, comprising:
a first shaft configured to extend generally along a vertical axis of the row unit;
a first plurality of discs distributed along the first shaft, wherein each disc of the first plurality of discs is non-rotatably coupled to the first shaft, and the first shaft is configured to rotate in a first rotational direction to drive the first plurality of discs to rotate in the first rotational direction;
a second shaft configured to extend generally along the vertical axis of the row unit;
a second plurality of discs distributed along the second shaft, wherein each disc of the second plurality of discs is non-rotatably coupled to the second shaft, and the second shaft is configured to rotate in a second rotational direction, opposite the first rotational direction, to drive the second plurality of discs to rotate in the second rotational direction;
wherein the first plurality of discs and the second plurality of discs are configured to engage a plant stalk, and each disc of the first plurality of discs is positioned proximate to a respective disc of the second plurality of discs to establish a sheer cutting force on the plant stalk to cut the plant stalk.

18. The stalk cutting assembly of claim 17, comprising:
a first gear non-rotatably coupled to the first shaft; and
a second gear non-rotatably coupled to the second shaft;
wherein the first and second gears are engaged with one another.

19. The stalk cutting assembly of claim 17, wherein each disc of the first plurality of discs has a flat side and a tapered side, each disc of the second plurality of discs has a flat side and a tapered side, and the flat side of each disc of the first plurality of discs faces the flat side of the respective disc of the second plurality of discs.

20. The stalk cutting assembly of claim 17, wherein at least one disc of the first plurality of discs is notched, at least one disc of the second plurality of discs is notched, or a combination thereof.
